(19) United States
(12) Patent Application Publication
(10) Pub. No.: US 2013/0111435 A1
(43) Pub. Date: May 2, 2013

(54) REDUCING OBJECT SIZE BY CLASS TYPE ENCODING OF DATA

(71) Applicant: Thomas W. Rudwick, III, Austin, TX (US)

(72) Inventor: Thomas W. Rudwick, III, Austin, TX (US)

(21) Appl. No.: 13/284,552

(22) Filed: Oct. 28, 2011

(51) Int. Cl. G06F 9/44

(52) U.S. Cl. 717/108

(57) ABSTRACT

A system and method for representing a state of an object by the object's type. A method includes receiving a request to change a state of an object. In various embodiments, the object may correspond to an instance of a class. Responsive to the request, the method includes changing the type of the object from a first type that corresponds to the first state to a second type that corresponds to the second state. There is no explicit representation of the state of the object included in the object. Rather, the object type is used to represent its state. Changing an object's type includes creation of a new object that corresponds to the second type, and storing the new object at the same location in memory wherein the original object was stored. A memory allocation is not performed as part of the creation of the new object.

### BACKGROUND OF THE INVENTION

1. Field of the Invention

This invention relates to computer systems, and more particularly, to managing objects in a computing system.

2. Description of the Relevant Art

The performance of computer systems is dependent on both hardware and software. As those skilled in the art know, program code is typically written in a source language which is subsequently compiled into object code for execution on a given machine. In some cases, compilation to a final object code format may take place well in advance of its execution. For example, program source code may be compiled to object code which is stored on a computer readable storage medium (e.g., a computer readable disk, flash drive, or other media). This medium may then sold by a software vendor to numerous customers who then install the object code on their computing systems where it may be accessed for execution. In some cases, such code may be conveyed via network communication, or otherwise as is increasingly common. In other cases, source code is translated to an intermediate code type (such as bytecode) which is conveyed to others for execution. In these cases, the target machine may itself have a virtual machine or other components configured to translate the intermediate code representation to an object code for execution by the particular machine.

Whichever paradigm is utilized for compiling source code, as the resulting compiled code is generally intended for execution on a particular type of machine (e.g., a machine utilizing a particular microprocessor architecture, or family of architectures), this code must generally adhere to particular requirement of the target machine. Generally speaking, processors and processor types have addressing mechanisms which are designed to access and manage data in a particular way. For example, processors are not generally designed to address and access data in arbitrary sized units. Rather, processors are generally designed or optimized to address and access data in what are referred to as “word” sized units. While variations exist, common word sizes are 32 bits and 64 bits. Therefore, a processor with a word size of 32 bits may address data as 32 bit (or 4 byte size) units. The consequence of such a design is that if such a processor attempts to access data on other than a 32 bit byte boundary, an access violation or fault may occur.

Given the above considerations, compilers generally have data alignment requirements. Because of such requirements, more memory than needed may be allocated for storage of particular data. For example, program code may include a variable used to represent one of two state (e.g., a flag of some type). As it is only necessary to represent one of two possible states, a single bit would suffice for representation of the state. However, due to program code alignment considerations, a full word sized amount of memory may be allocated for storage of this single bit. In other words, a full eight bytes of storage could be allocated for storage of such a variable. In database and other systems where large numbers of data objects may be used, this additional storage used may be multiplied many thousand, millions, or billions, of times. Consequently, the storage overhead due to the above discussed alignment requirements may become significant.

In view of the above, efficient methods and mechanisms for managing objects, and memory utilization, in a computing system are desired.

### SUMMARY OF THE INVENTION

Systems and methods for managing objects in a computing system are contemplated.

Embodiments of a method are contemplated in which an object in a computing system may be in one of multiple states. Typically, the state of such an object may be represented within the object—for example, using a state identifier (state ID). However, in various embodiments, a method is contemplated that does not use an explicit representation of an object's state. Rather, the method includes representing the state of an object by its type. Accordingly, multiple distinct types are used to represent the state of an object. Should a change in state of an object be desired, then the object's type is changed from a first type to a second (different) type. In various embodiments, each distinct type corresponds to a different class in an object oriented system. Objects in such a system represent instances of these classes. By detecting an objects type, whether explicitly or implicitly, the objects state may be determined.

In order to change an object from one type to another, embodiments are contemplated in which a new object is created to represent the object in the new state. In order to avoid memory allocation overhead, the method may perform object creation using an operation which does not invoke or cause memory allocation. Such methods may take an identification of a memory location of the current object and use it as if it had been allocated for the new object. Data initialization of the new object, at this existing memory location, is then performed. In various embodiments, a change in the data content of the object may not be desired. Therefore, initialization of the new object may expressly avoid initialization of the preexisting data members. In some embodiments, each object includes a pointer to a table for use in accessing methods and functions of the object. In such cases, initialization of a new object may include changing this pointer to identify a new table that corresponds to the new type.

These and other embodiments are described herein and will be more fully appreciated upon reference to the following description and drawings.

### BRIEF DESCRIPTION OF THE DRAWINGS

FIG. 1 illustrates one embodiment of memory data alignment in a computing system.

FIG. 2 illustrates one embodiment of an object with corresponding type and state identification.

FIG. 3 illustrates one embodiment of memory allocation and data alignment in a computing system.

FIG. 4 illustrates one embodiment of an object with different states represented by different types.

FIG. 5 illustrates one embodiment of memory allocation in a computing system for multiple program classes.

FIG. 6 is a flow diagram illustrating one embodiment of a method for managing object states in a computing system.

FIG. 7 illustrates one embodiment of an object state change in a computing system.

FIG. 8 illustrates one embodiment of a method for managing object states in a computing system.

FIG. 9 illustrates one embodiment of program code for managing objects in a computing system.

FIG. 10 illustrates one embodiment of a method for performing compilation.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

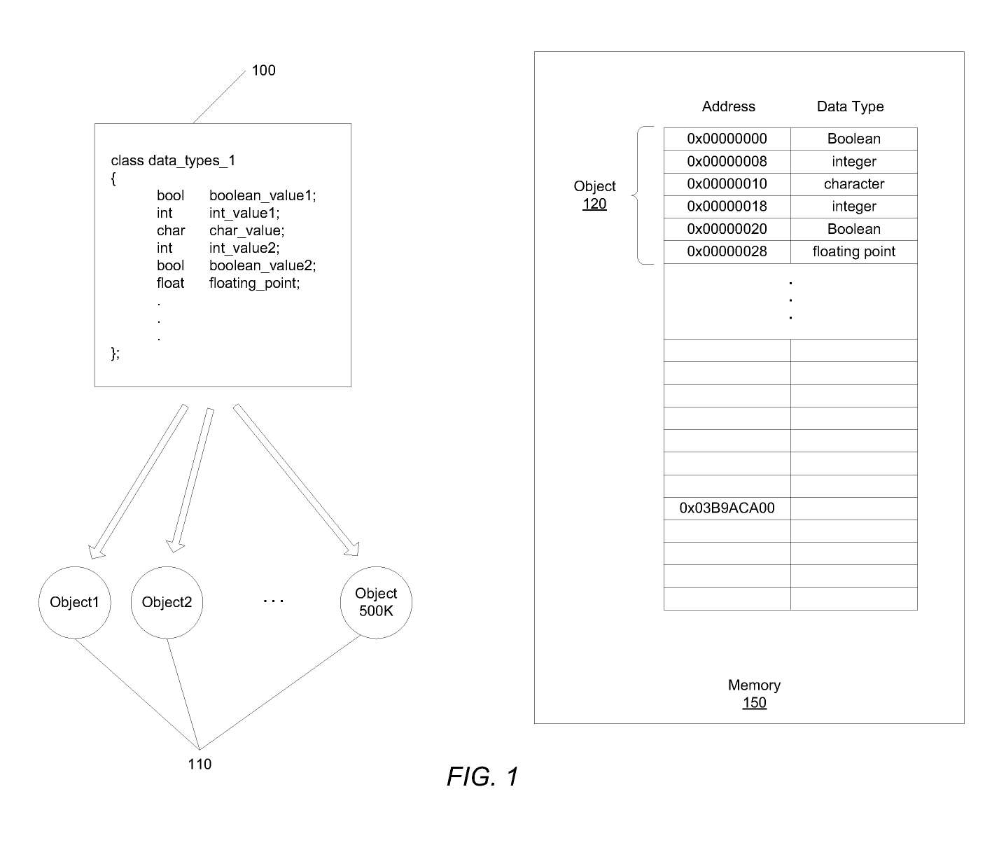

Turning now to FIG. 1, pseudocode 100 depicting sample program source code and how corresponding data may be stored in memory 150 are illustrated. In the following discussion, various pseudocode code samples will be provided for purposes of discussion. As may be appreciated by those skilled in the art, various programming languages may be used to implement the methods and mechanisms described herein, and the code fragments provided are not intended to include all code definitions, declarations, and so on, or to be limiting. In the pseudocode 100 shown, a class definition “data_types_{—}1” is provided that includes a number of data members or variables. These data members include Boolean_value1 which is of type Boolean (“bool”), int_value1 which is of type integer (“int”), char_value which is of type character (“char”), int_value2 which is of type int, Boolean_value2 which is of type bool, and floating_point which is of floating point type (“float”).

Generally speaking, a Boolean type data member may require only a single bit to represent its value (e.g., “1” for True, and “0” for false). Integer and floating point data types may (depending on the implementation) be represented by a 4 byte value, and a character by a single byte value. Assuming these to be how the data members are represented, then the data members shown in pseudocode 100 may be represented by a total of 1 bit (bool)+4 bytes (int)+1 byte (char)+4 bytes (int)+1 bit (bool)+4 bytes (float)=106 bits. If in a given embodiment there are 500K objects 110 instantiated which are based on this class, then this data may be represented by roughly 6½ megabytes (MB) of storage (500K×106 bits). However, due to data alignment requirements, the actual storage used to store this data may be significantly greater.

For example, in FIG. 1, memory 150 illustrates how these data members may be stored for a given object 120. Memory 150 depicts a storage address (Address) and the type of data stored in the corresponding location (Data Type). Data member boolean_value_{—}1 is stored in memory beginning at location 0×00000000 ('00), and following boolean_value_{—}1 is int_value1. However, while only a single bit is needed to represent the Boolean value at location '00, data alignment requirements result in int_value1 being stored beginning at memory location 0×00000008 ('08). In other words, a full eight bytes of storage are used for the single bit Boolean value at location '08. Consequently, there are 55 bits of storage overhead for the single bit Boolean value. Depending on the implementation, these overhead bits may simply be padding, added (non-functional) data members, or otherwise. Similar overhead due do data alignment requirements is found for storage of each integer type (8 bytes for storage of a 4 byte value), character type (8 bytes for a single byte value), and the floating point type (8 bytes for a 4 byte value). In some cases a compiler may seek to pack smaller data types into portions of the larger alignment size. Nevertheless, additional storage generally results from the alignment requirements. Therefore, in this example, address locations 0×00000000-0×000037 are used to store the data members which were discussed above as requiring 106 bits for representation. However, rather than 106 bits being used for storage, a full 384 bits (48 bytes) of memory are utilized for storage (i.e., an additional 278 bits). If in a given embodiment there are 500K objects 110 instantiated which are based on this class, then approximately 23 MB of storage may be utilized (500K×384 bits) which is nearly four times that required to represent the data values.

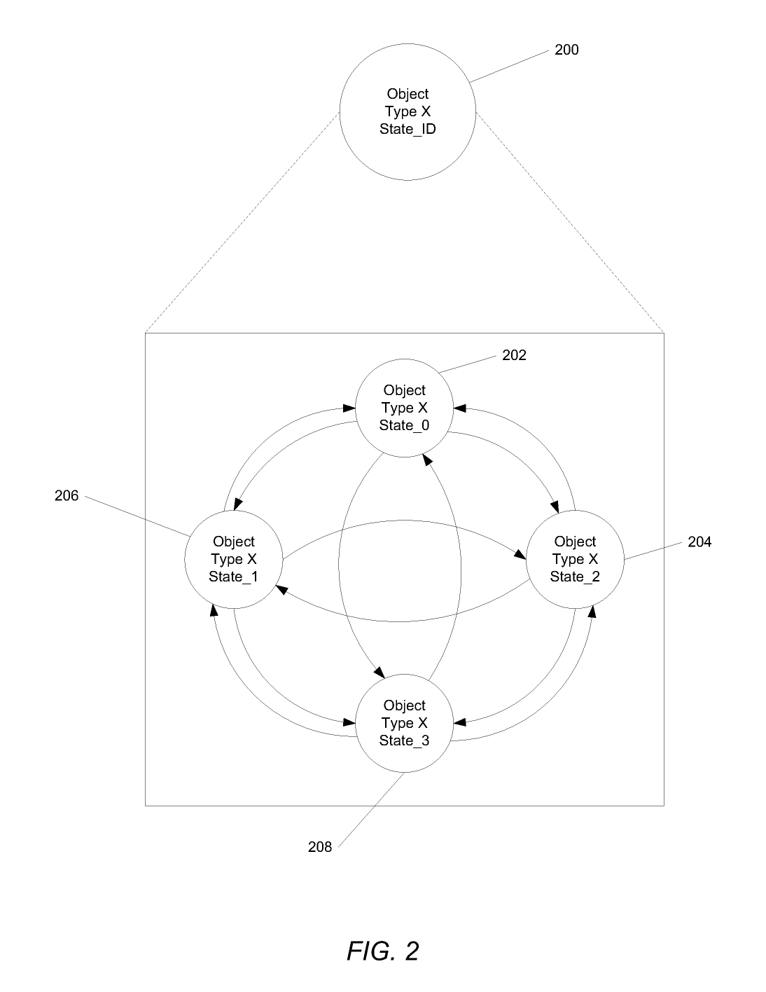

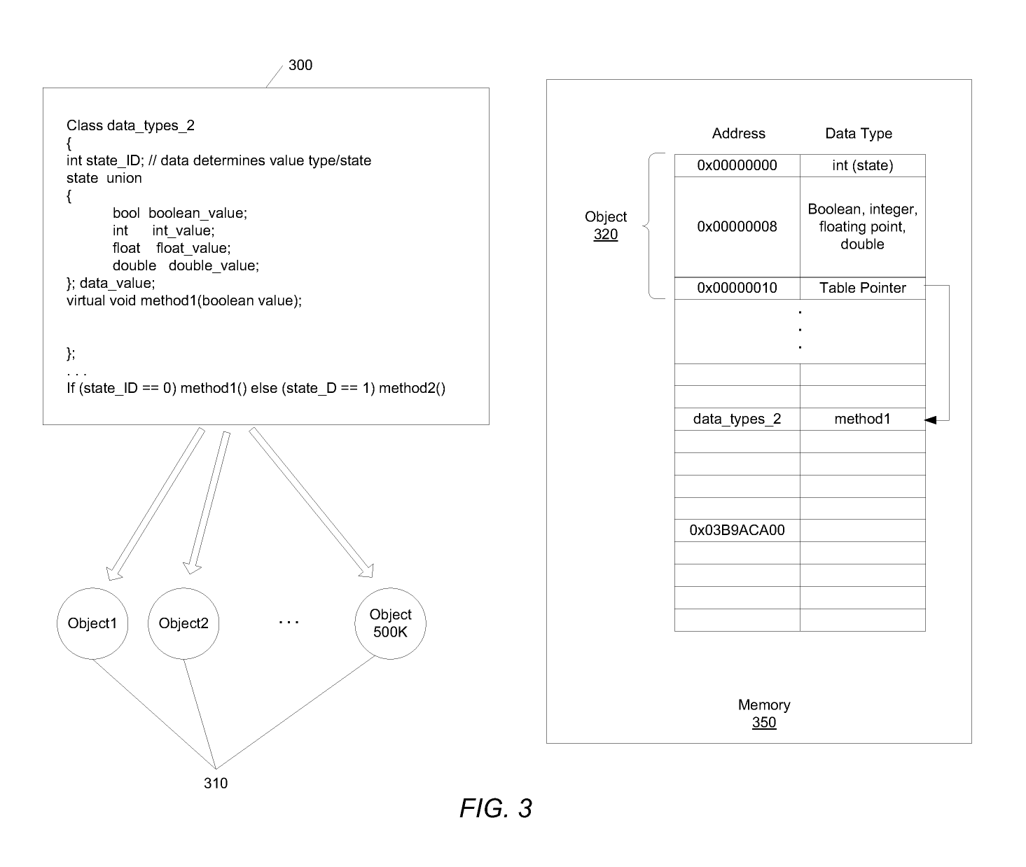

Even in cases where seemingly little additional data is required in a particular object, data alignment and memory allocation techniques may result in significant overhead. FIG. 2 illustrates an embodiment in which an application (e.g., database type application) includes an many objects such as object 200. As shown, object 200 includes both a type (Type X) and a state (State_ID). In the example shown, a given object may assume be in one of four different states—State_{—}0 202, State_{—}1 206, State_{—}2 204, or State_{—}3 208. Arcs are shown to illustrate that in this embodiments an object may transition from any state to any other state (intended for illustrative purposes only). FIG. 3 illustrates pseudocode 300 that may then corresponds to such an object(s), and a sample memory 350 layout. As shown in FIG. 3, pseudocode defines a class data_types_{—}2 including data members state_ID and data_value which is of a union type. As there are four possible state, at least two bits are required to represent the state of an object. In various embodiments (e.g., as provide in many C and C++programming languages), a union type may be used store one of a number of data types within a given storage location in an overlapping/superimposed manner. The storage location allocated will generally be at least as large as the largest possible data type that may be stored.

In the example shown, data_value is of the union type and may be one of a Boolean, integer, floating point, or double precision data type. Such an approach may, for example, be used when it is known that data_value may be any of, but only one of, these data types within a given object. In this manner, a common (base) object type may be used for representation of a number of object types which could be storing a data_value of different types. While there are many reasons a given object may be associated with more than a single state, it is often desirable or necessary to know the current state of an object in order to determine which operations are suitable for the given object. Therefore, a state_ID such as that in pseudocode 300 may be included to identify the current state of an object. Also shown in the pseudocode 300 is an illustration that the current state may affect which of multiple methods may be used. For example, if the current state is “0”, then method1( ) may be called; otherwise, method2( ) may be called.

In FIG. 3, memory 350 depicts a possible memory layout for an object 320 corresponding to the pseudocode 300. While only two bits may be required to represent the state (state_ID, data alignment requirements may result in more storage being utilized (8 bytes in the current example). In this case, as a union is used for data_value, 8 bytes may be used to represent data_value regardless of its current type (Boolean, integer, floating point, or double). While there is seemingly less storage overhead in the example of FIG. 3 than in FIG. 1, the overhead is nevertheless not insignificant. Considering the representation of the state of the object itself, 64 bits of storage are used to represent a two bit state—resulting in overhead of 62 bits for a single object. Assuming again a database including 500K objects 310, nearly 4 MB of storage (500K×8 bytes) is used to store just the state information alone that may be represented by 125 kilobytes (KB) of data (500k×2 bits). If only two states were possible for the object, then only a single bit would be need to represent that state however, the storage allocated would still be 64 bits (in this example) to store the state. Therefore, even the simple addition of a state identifier to the object results in significant storage overhead.

It is noted that there is typically metadata that is also stored as part of an object (such metadata has not been included in the storage requirements discussed above). In the example of FIG. 3, one type of metadata (Table Pointer) is shown in the memory 350. The Table Pointer at memory location 0×00000010 represents a type of metadata for the object (320) that is used to identify where in memory the code for method1 may be found. In various embodiments, Table Pointer points to a table which in turn includes pointers to other locations in memory. For example, the table may be a virtual method or function table, which may also be referred to as a vtable, dispatch table, or otherwise.

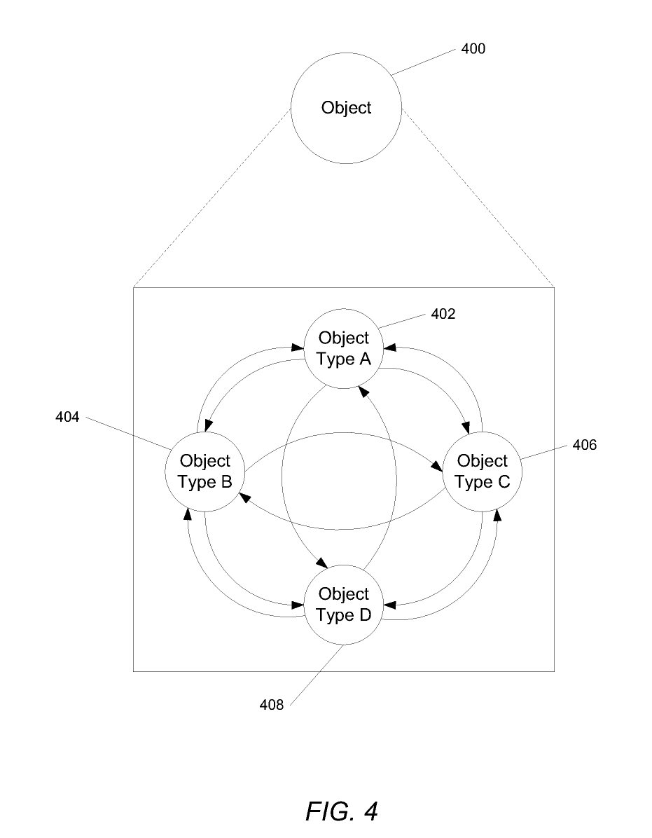

Turning now to FIG. 4, one embodiment of an approach for managing objects that may assume one of multiple states is shown. In this example, an object 400 is shown that again may be in one of four states. However, in this example, there is no explicit state identifier included in the object. Rather, the object type itself is used to represent the state of the object. For example, an object type A 402 is used to represent a first state of the object, a type B 404 to represent a second state, a type C 406 to represent a third state, and a type D 408 to represent a fourth type. As there are multiple distinct object types being used to represent different states of a given object, transitions between these states may require creation and destruction of objects, and all of the overhead that entails, when transitioning from one state to another. Additionally, transitioning between states may cause a loss of any data members of an object—which in turn may require recreation of the data members in the newly created object. However, as will be discussed below, embodiments of a method and mechanism are described wherein such overhead may be largely eliminated.

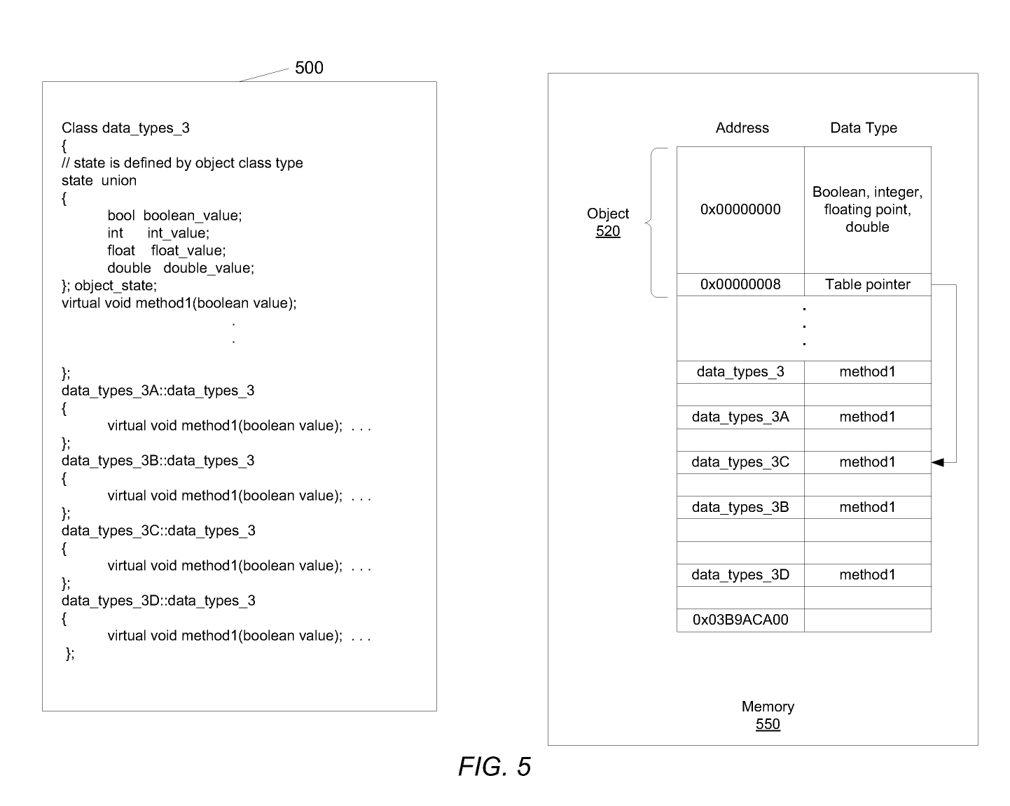

FIG. 5 illustrates one embodiment of pseudocode 500 and a sample corresponding memory data layout 550. In this example, there is no data member (e.g., state_ID) to represent a state of the object. Rather, new classes have been created to represent different states of a given object. In particular, four subclasses of a parent class data_types_{—}3 have been created, each having an appended alphanumeric character (A-D) to distinguish between the classes and corresponding states. In addition, the parent class data_types_{—}3 includes a union as in the previous example, and also includes a method (or function) called “method1” with a Boolean type parameter. Each of the subclasses data_types_{—}3A-data_types_{—}3B also include a method by the name of method1. In this embodiment, the method1 function of the parent class may be overridden by a subclass. In this particular example, this is accomplished by declaring method1 to be virtual.

As those skilled in the art will appreciate, permitting an inheriting class to override the functionality of base class method is an important aspect of polymorphism in object oriented programming. In the present example, the implementation shown resembles that of the C++ programming language to declare methods virtual and override them in a subclass. However, it is noted that other implementations and programming language paradigms for implementing polymorphism and related concepts are possible and are contemplated.

Also shown in FIG. 5 is one embodiment of how data corresponding to the code 500 may be laid out in memory 550. In the example shown, an object 520 is stored in the memory 550. Object 520 includes storage for the union (as in the previous example), but no storage for identification of a state identifier. In this example, object 520 corresponds to an object of type data_types_{—}3C. Therefore, the Table Pointer at location 0×00000008 points to a table for data_types_{—}3C. As can be seen in FIG. 5, each of data_types_{—}3A-data_types_{—}3D has its own table stored in memory 550. In this manner, each object type (data_types_{—}3A-data_types_{—}3D) may have its own implementation of the method named method1. In various embodiments, there is only one virtual method table for each class type. Therefore, there is not needed a separate virtual method table for every instantiated object. Consequently, while the approach of FIG. 5 includes additional code to support the added (sub)classes for the different states of the object, this additional code need only appears once within the memory 550. Further, the elimination of the state identifier from every instantiated object in the embodiment of FIG. 5 may result in significantly less storage being required as the number of instantiated objects grows.

While an approach such as that depicted in FIG. 5 may enable a reduction in the storage overhead for a given object (whether in a cache, system memory, persistent storage such as a storage array, or otherwise), the existence of different distinct objects (types) to represent each state suggests added overhead for memory allocation and reclamation/destruction, and data copying/movement, at runtime. For example, if a given object is currently in state 0 and is to transition to a state 1, then new memory may be allocated for a new object to represent state 1, the contents of the object representing state 0 copied to the new object (object 1), and object 0 destroyed. Another state change would require repeating this process. In order to provide a more efficient approach in terms of both storage and processing overhead, embodiments are contemplated in which there is no need to either perform the above described memory allocation or data copying/movement.

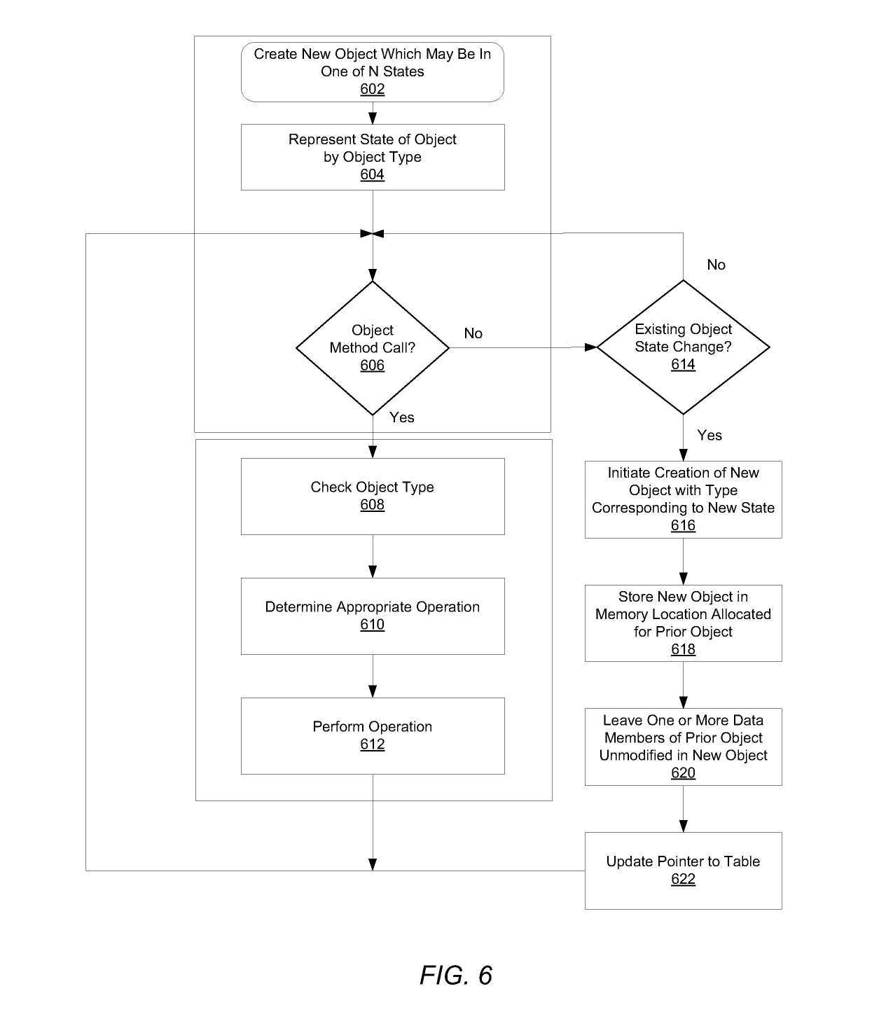

FIG. 6 illustrates one embodiment of a method for managing objects in a computing system wherein multiple states of a given object are represented by different object types. In the embodiment described, when an object changes from one state to another, we desire the object to remain the same object but with a different state. In other words, even though we may use a distinct object and/or object type to represent a state change, in essence we really do not want a different object—we wish the object to remain the same object. The method shown begins with the creation of an object which may be in one of N possible states (block 602) and a state of the object is represented by its type (block 604). For example, creation of the new object will generally entail allocation of memory (e.g., via an alloc( ) malloc( ) new, etc.) for storage of a given data type.

Creation of a new object also generally entails initialization of the object once it is created. For example, various data members of the object may be initialized to particular values, metadata such as virtual method table pointers may be established, and so on. Taking FIG. 5 as an example, an object may be created that corresponds to a state “C” (e.g., of possible states “A”, “B”, “C”, and “D”). Therefore, according to C++ syntax, we may have code such as the following:

. . . new data_types_{—}3C

As data_types_{—}3C includes a virtual method (method1), a portion of how it is laid out in memory may resemble that of object 520 in FIG. 5, with storage allocated for data members and metadata such as the Table Pointer. If a call (decision block 606) to a method of the object is detected (e.g., a call to method1), then the proper method1 must be invoked. In the present example, data_types_{—}3C is a subclass of data_types_{—}3, both of which have a method1_. Therefore, the object type must be determined (block 608) in order to identify the proper method to call. Having identified the object type as data_types_{—}3C, the appropriate method is identified (block 610) and execute (block 612).

If a state change for the object is detected (conditional block 614), then a state change is performed. It is noted that while block 614 is shown to follow block 606, then need not be the case. The diagram of FIG. 6 is for illustrative purposes only. In other embodiments, steps shown in FIG. 6 may occur in a different order, some steps shown may not be present, other steps now shown may be present, some steps may be performed in parallel, and so on. Having determined a change in state of the object is desired, creation of a new object to represent the new state is initiated (block 616). In the discussion above, creation of a new object included the allocation of memory. However, in the present embodiment, a new object is created without allocating new memory. In one embodiment, this is accomplished by using the “placement new” operation of the C++ programming language (or a similar operation). The placement new operation in C++ is an operation that takes as an argument a pointer or identification of memory that has already been allocated. In contrast to the standard “new” operation which involves the process of allocating memory, the placement new operator assumes the desired memory has already been allocated.

For example, if a given object is currently in a state “C” (e.g., data_types_{—}3C) and the object's state is changed to a state “A” (e.g., data_types_{—}3A), then in one embodiment a placement new operator may be used to change the state of the object from state C to state A. As we do not desire the object to really change—only its state—this may effectively be accomplished as follows:

//assumes object1 is a pointer to an object of type data_types_3C
new (object1) data_types_3A

In the above code, the process of memory allocation is not performed. Rather, the operator “new” assumes the memory has already been allocated and is at the location pointed to by object1 (block 616, 618). The constructor for data types 3A is then called to initialize the object at location object 1. However, as we don't wish to change the data members of the object (we merely want to change the object's state), the method used must seek to avoid making any changes to the object's data. In one embodiment, the constructor called as part of the above state change is particularly designed to leave the values of the data members unchanged (block 620). However, this constructor is configured to change the virtual table pointer (block 622) of the object. Changing this table pointer may be viewed as an implicit representation of the state of the entire object. In other words, while the state of the object is not explicitly included in the object, the table pointer may be used as a type of encoding of the state of the object. Therefore, we have effectively changed the state of the object by modifying the existing object to be an object with a different type (without performing the memory allocation process) at the identical location of the object in its prior state, and we have left the data members undisturbed. To this extent the object may (for the most part) look identical before and after the state change. However, a change in the virtual table pointer effectively causes a change in type due to each class having its own virtual method table. Accordingly, a call to method1 will call the method corresponding to data_type_{—}3A instead of data_type_{—}3C. Note that when making a call to method1 there is no explicit check as to the type or state of the object making the call. Rather, the correct method is automatically called due to the virtual method table pointer having been changed. In this manner, a change in state of the object has been accomplished by changing its type—without allocating new memory or copying data members from the previous object type to the new object type.

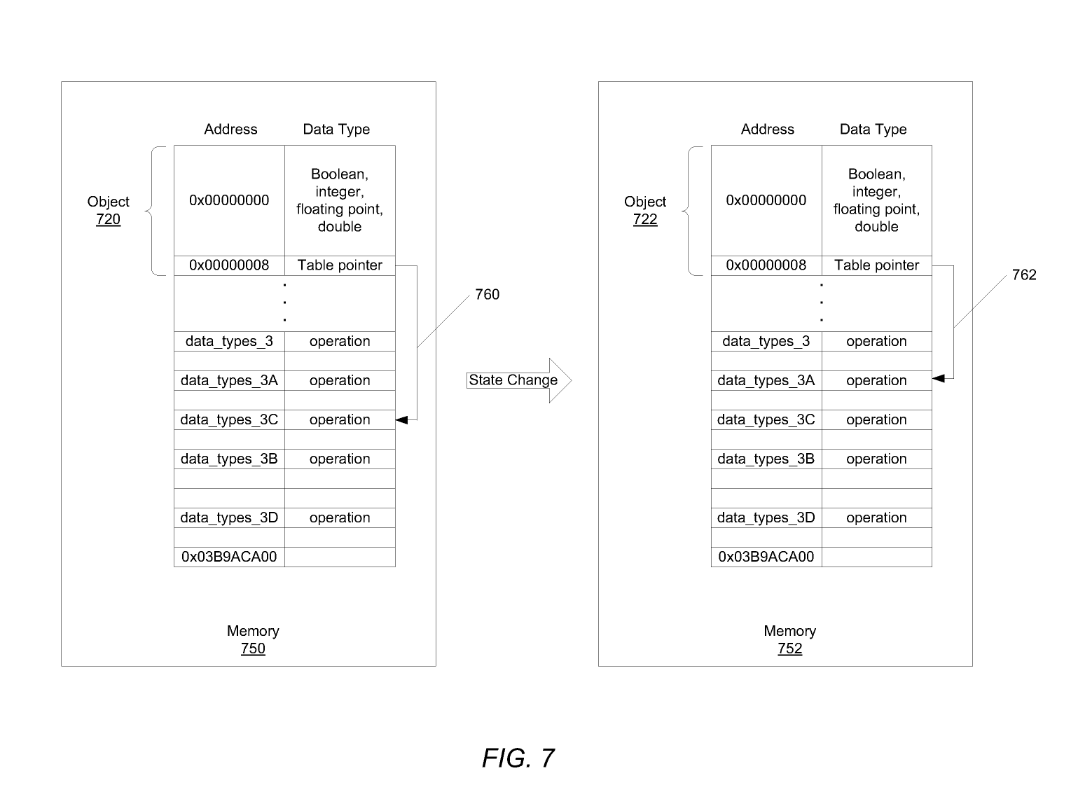

FIG. 7 provides a graphical depiction of the object in memory both before and after the state change. In FIG. 7, memory 750 is shown to include an object 720 prior to a state change. Memory 752 in the figure shows the object (722) after a state change. As in the previous example, the object is initially in a state C (data_types 3C) and is changed to a state A (data_types_{—}3A). Object 720 includes data members stored beginning at location 0×0000000 and a virtual method table pointer (Table Pointer) at location 0×00000008. The virtual method table pointer in the original object 720 points to a table 760 that corresponds to the data type data_types_{—}3C. Therefore, a call to a method by the object 720 will utilize the method identified by the table 760.

Following the procedure described in FIG. 6, a state change of the object 720 from state C to state A is desired. In one embodiment, a placement new type operation is called with an identification of the memory location of object 720. This placement new type operation is configured to initialize or construct a new object 722 in the same location as that of object 720. In one embodiment, a memory allocation process is not performed. As part of the initialization or construction, the data members of the object 720 in its previous state are left undisturbed. In other words, in one embodiment, the contents of the memory locations 0×00000000-0×00000007 are not copied from object 720 to object 722. Rather, the contents of these memory locations simply remain the same. In addition, the virtual method table pointer (Table Pointer) is changed so that it now points to the table 762 for data types 3A. Such a change in the table pointer may be accomplished by a call to the constructor for the class or object type data_types_{—}3A.

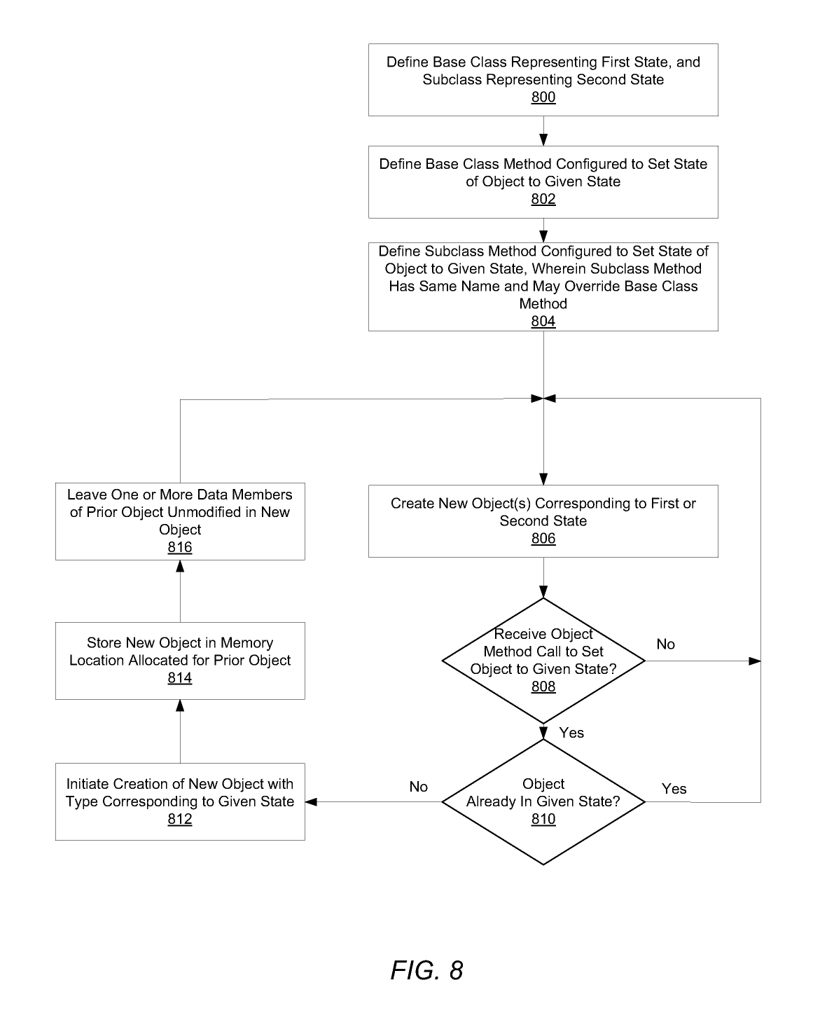

Turning now to FIG. 8, one embodiment of a method for defining and managing objects in a computing system is shown. For purposes of discussion, the embodiment described in FIG. 8 uses an object that may be in one of two states. The method generally begins by defining a base class representing a first state of an object, and defining a subclass of the base class that represents a second state of the object (block 800). In addition, a base class method configured to set the state of the object to a given state is defined (block 802). Similarly, a subclass method configured to set a state of the object to a given state is defined (block 804). In one embodiment, the base class method to set the state may be overridden by the subclass method to set the state (e.g., using a virtual method or other approach).

Having defined the base and subclasses, a new object(s) may be created (block 806). This new object may be created in either the first state or the second state. For example, if it desired that the object be in the first state then an object of the base class type may be created. Alternatively, if it is desired that the object be in the second state then an object of the subclass type may be created. If then a method call by an object to set its state is detected (conditional block 808), a determination may be made as to whether the object is already in the desired state (conditional block 810). For example, if an object in the first state calls a method to set the object to the first state, then the method call may (effectively) do nothing as the object is already in the desired state. Alternatively, if the object is not already in the desired state, then the method call may cause a change in state as described above (e.g., as described in FIG. 6 and FIG. 7). Such a change in state will result in the object changing from an object of the base class type to the subclass type. For example, creation of a new object type may be initiated (block 812), the new object will be stored in the identical location as the old object (block 814), and data members of the prior object are retained in the new object (block 816). It is noted that since the new object is in the identical location of the prior object, the pointer to the object remains unchanged. To this extent, the object (as identified by the object pointer) appears to be the same object. For example, in a C++ implementation of the methods and mechanisms described herein, the “this” pointer remains the same. In various embodiments, the class defined to represent each state of an object includes the same data members. In this manner, when a new object is created in the same location in memory as a previous object, the number, size, and content of the data members may generally be the same so as to avoid data corruption.

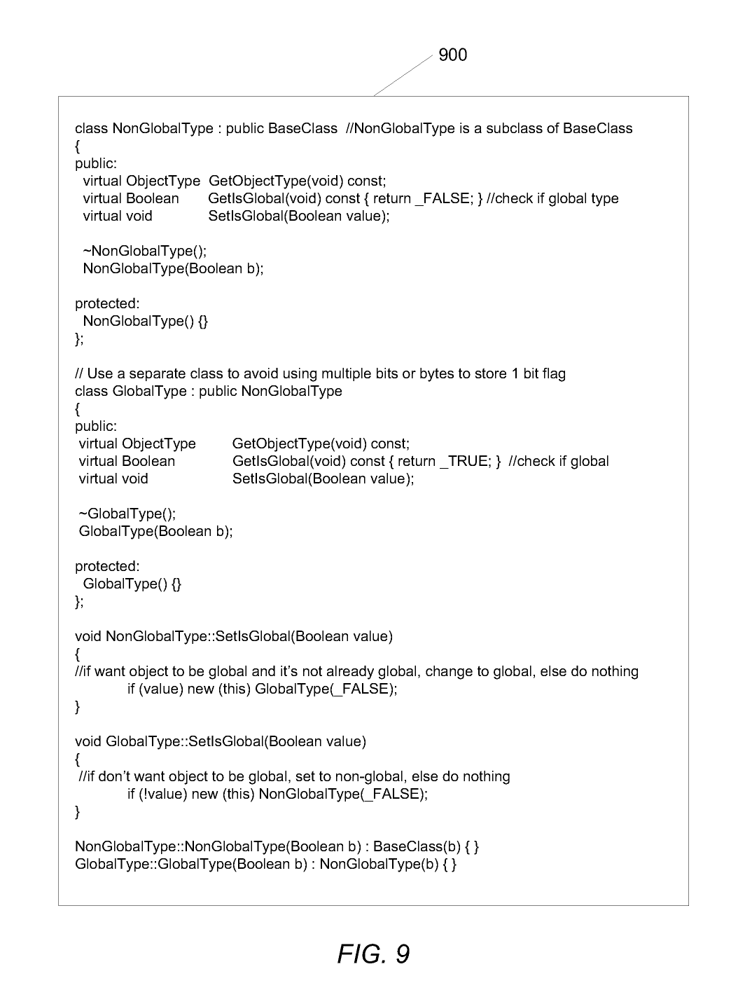

FIG. 9 illustrates one embodiment of program code 900 used for a method similar to that described in FIG. 8. In this example, C++ type code is used for illustrative purposes. However, other programming languages could be used for implementation of the methods and mechanisms. In the example shown, there are two class declarations—NonGlobalType and GlobalType. The first class, Non GlobalType, is declared to be a subclass of a parent class called BaseClass as follows:

class NonGlobalType:public BaseClass

In addition, class NonGlobalType declares the following two virtual methods:

| | |
|---|---|
| virtual Boolean | GetIsGlobal(void) const { return _FALSE; } |
| virtual void | SetIsGlobal(Boolean value); |

The first method, GetIsGlobal, is configured to check whether the calling object is of the GlobalType. As this method is part of the NonGlobalType class, it returns a value of false (i.e., the object is not of the type GetIsGlobal). In addition, a method SetIsGlobal is defined which is configured to take a Boolean value parameter. If the parameter evaluates to true, then an attempt is made to make the calling object an object of type GlobalType. In addition to the above, a destructor (˜NonGlobalType( )) is declared. Finally, two constructors are declared, one which takes a parameter and one which does not. As will be described shortly, these two distinguishable constructors are created so that we may control how an object is initialized when created. These declaration are as follows:

NonGlobalType(Boolean b);
NonGlobalType( ) { }

In addition to the above, the code 900 in FIG. 9 also includes the class GlobalType. This class is a subclass of NonGlobalType and is declared as follows:

class GlobalType:public NonGlobalType

As in the parent class, two virtual methods are declared. The first method, GetIsGlobal, overrides the parent class method and is also configured to check whether the calling object is of the GlobalType. However, in this case, as this method is part of the GlobalType class it returns a value of true (i.e., the object is of the type GetIsGlobal). In addition, a method SetIsGlobal is defined which is configured to take a Boolean value parameter. If the parameter evaluates to true, then an attempt is made to make the calling object an object of type GlobalType.

| | |
|---|---|
| virtual Boolean | GetIsGlobal(void) const { return_TRUE; } |
| virtual void | SetIsGlobal(Boolean value); |

In addition to the above, a destructor (˜GlobalType( )) is declared. Finally, two constructors are declared, one which takes a parameter and one which does not. As in the base class, two distinguishable constructors are created so that we may control how an object is initialized when created. These declaration are as follows:

~GlobalType( );
GlobalType(Boolean b);
GlobalType( ) { }

Also shown in FIG. 9 is code for the SetIsGlobal method for each of the above class types, as well as code corresponding to the parameterized constructors mentioned above. The code for the SetIsGlobal type method of the NonGlobalType class is as follows:

void NonGlobalType::SetIsGlobal(Boolean value)
{
if (value) new (this) GlobalType(_FALSE);
}

In the body of the above method, a placement new operation is conditionally called in dependence on whether the parameter “value” evaluates to true or not. If “value” evaluates to true (e.g., we wish to change the state of the object to the type

GlobalType), then a new operation is called with the “this” pointer as a parameter. In one embodiment, the “this” pointer corresponds to the calling object which is of type NonGlobalType and identifies where in memory this object is located.

As this is a placement new type of operation, a memory allocation procedure is not performed. However, a call to the constructor of the class for the other type (i.e., not the constructor for the existing type of object of corresponding to the this pointer, but the constructor for the GlobalType) is made. If a call to the default constructor were made, then whatever initializations performed by the default constructor would be performed, including a change to the virtual method table pointer. However, as we do not desire any changes to the data members of the object (we merely want to change its state), an alternative distinguishable constructor has been defined and is called in this case. Here a parameterized constructor (GlobalType(_FALSE)) is called to distinguish it from the default constructor.

In this context, a parameterized method simply means that the constructor includes a parameter in the call which permits us to distinguish it from the default constructor which does not include a parameter. In various embodiments, this parameterized constructor is expressly configured to not change the data members. As we may have other data members or actions we wish performed at initial creation of an object, we may use this separate constructor for this purpose of avoiding changes to the data members. If in the above example, a call is made to SetIsGlobal by an object of the type NonGlobalType, and the parameter “value” evaluates to false (i.e., we do not wish the object to be of the type GlobalType), then the clause following the if expression is not executed. In the embodiment shown, when the expression evaluates to false, the method simply returns without performing a state change operation as the object is already not an object of the GlobalType.

Code 900 in FIG. 9 also includes a definition of the method SetIsGlobal for the class GlobalType as follows:

void GlobalType::SetIsGlobal(Boolean value)
{
if (!value) new (this) NonGlobalType(_FALSE);
}

In contrast to the method of the class NonGlobalType, this method checks whether the parameter “value” evaluates to false. Therefore, if an object of type GlobalType calls the method SetIsGlobal with a parameter of false, the conditional if expression will evaluate to true and perform the following clause. In other words, if the object is of type GlobalType and a call is made to SetIsGlobal with parameter set to false (i.e., we do not want the object to be of the GlobalType), then a change in state is performed by the following placement new operation and constructor call of the class of the other type (NonGlobalType). As in the previous case, a special parameterized constructor may be created which is expressly configured to leave the data members unchanged.

Finally, code 900 in FIG. 9 includes definitions for the parameterized constructors discussed above. In the embodiment shown, a call to the parameterized constructor of either the NonGlobalType class or the GlobalType class results in a call to a constructor of the parent class BaseClass. For example, the following constructor code for the NonGlobalType class calls the constructor baseClass(b):

NonGlobalType::NonGlobalType(Boolean b):BaseClass(b) { }

The following constructor code for the GlobalType class calls the constructor for the class NonGlobalType.

GlobalType::GlobalType(Boolean b):NonGlobalType(b) { }

However, as noted above, the call to the constructor GlobalType calls the constructor BaseClass. Therefore, in each case the constructor causes the actions of its parent class constructor to be executed. However in various embodiments none of the constructors down to the least derived class perform any actions so no code is generated. In various embodiments, as discussed above, the constructor BaseClass(b) is expressly defined so as not to change the data members of the object. While these constructors discussed above result in a call to the same constructor, other embodiments could have the constructor defined within the class itself and have it designed to leave the data member values unchanged. Numerous such alternative embodiments are possible and are contemplated. It is noted that while the above description discusses virtual methods which enable automatically calling the correct method for a given object, other embodiments could use alternative approaches. For example, in other embodiments type checking could be explicitly performed at runtime (e.g., using run time type information, RTTI, or some other approach). Using such a type checking mechanism, an appropriate method for a given object (type) could be called. In this manner, one could also avoid explicitly providing a state identifier within the object. Various such alternative embodiments are possible and are contemplated.

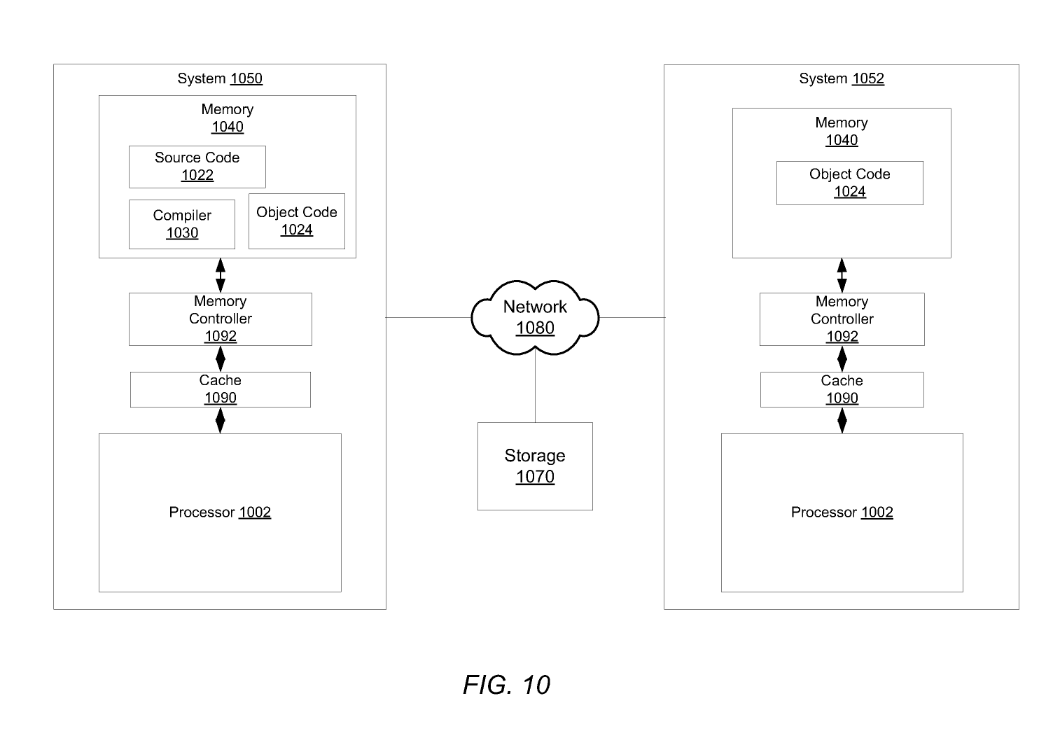

Referring to FIG. 10, a general overview of one embodiment of a computing system(s) is shown. As may be appreciated by those skilled in the art, the example shown in FIG. 10 is merely one of many possible embodiments. In the example of FIG. 10, two systems 1050 and 1052 are shown, each of which are coupled via a network 1080 to storage 1070. Storage 1070 may, for example, correspond to persistent storage such an a storage array for use in a database system, or otherwise. Systems 1050 and 1052 may or may not include a same architecture. The software applications, or source code 1022, written by a developer may be executed on a variety of machines, such as systems/platforms 1050 and 1052. A machine may refer to a computer, a mobile phone, a personal digital assistant (PDA), a server, or otherwise. A machine may include one or more processors 1002 comprising one or more processors, which is further described shortly.

Generally speaking, source code 1022 is written by a software developer, stored in memory 1040 within platform 1050, and may be compiled by a compiler 1030. This compiler 1030 may produce compiled object code 1024, which may be conveyed to a customer to execute on platform 1052. As previously discussed, in some cases the code produced by a compiler corresponds to an intermediate representation (which may generally be referred to as object code herein) which then undergoes further translation, interpretation, and/or compilation on a target machine. In the embodiment shown, copies of object code 1024 on platforms 1050 and 1052 are shown to illustrate the production of object code 1024 on platform 1050 and the execution of object code 1024 on platform 1052.

Platform 1050 may have one or more processors 1002, although only one is shown. Each processor 1002 may, for example, include a superscalar microarchitecture with one or more multi-stage pipelines. Alternatively, each processor may correspond to a virtual machine operable to interpret or otherwise execute program instructions. Each processor 1002 may be configured to execute instructions of software applications corresponding to an instruction set architecture (ISA) such as x86, SPARC®, PowerPC®, MIPS®, ARM®, or otherwise. Also, each processor 1002 may be designed to execute multiple strands, or threads. For example, a multi-thread software application may have each of its software threads scheduled to be executed on a separate pipeline within a processor 1002, or alternatively, a pipeline may process multiple threads via control at certain function units.

Each processor 1002 may comprise a first-level cache or in other embodiments, the first-level cache may be outside the processor 1002. Each processor 1002 and first-level cache may be coupled to shared resources such as a second-level caches and lower-level memory 1040 via memory controllers 1092. Interfaces between the different levels of caches may comprise any suitable technology. In other embodiments, other levels of caches may be present between a first-level cache and memory controller 1092. In one embodiment, an I/O interface may be implemented in memory controller 1092 to provide an interface for I/O devices to cache 1090, other caches located both internally and externally to processor 1002, and to processor 1002. Memory controllers 1092 may be coupled to lower-level memory, which may include other levels of cache on the die outside the microprocessor, dynamic random access memory (DRAM), dual in-line memory modules (dimms) in order to bank the DRAM, a hard disk, or a combination of these alternatives.

Generally speaking, compiler 1030 is used to produce object code 1024 from source code 1022. The source code 1022 stored in memory 1040 may be software applications written by a software developer in a high-level language such as C, C++, Fortran, or otherwise. The source code 1022 may be written to perform predetermined steps of an algorithm or method. One or more libraries may be used during the software development. These libraries, which may be written by the software developer, may include code and data that describe one or more subroutine definitions. These subroutines may be referenced for use by code in other files such as through a function call. The libraries may allow the sharing and changing of code and data in a modular fashion. The libraries may utilize references known as links to connect to executable files. A link-editor and a runtime linker (not shown), both used in later stages, may typically perform the process of linking

In various embodiments, the compiler 1030 may be configured to determine that particular application code may benefit from the methods and mechanisms described herein. In such a case, the compiler 1030 may automatically generate the additional code needed and perform suitable modifications to the code to perform the methods and mechanism. In this manner, the methods and mechanisms described herein may represent possible optimizations that may be performed by a compiler.

Various embodiments of the methods and mechanisms described herein may further include receiving, sending or storing instructions and/or data implemented in accordance with the above description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for use in a computing system, the method comprising:
receiving a request to change a state of an object stored at a given location in a memory from a first state to a second state;
changing a type of the object from a first type that corresponds to the first state to a second type that corresponds to the second state, wherein changing said type comprises:
initiating creation of a new object that corresponds to the second type; and
storing the new object at the given location in the memory.

2. The method as recited in claim 1, wherein said first type corresponds to a first class in an object oriented programming paradigm, and the second type corresponds to a second class in the paradigm.

3. The method as recited in claim 1, wherein the second class is a subclass of the first class.

4. The method as recited in claim 1, wherein creation of the new object does not include performing memory allocation.

5. The method as recited in claim 4, wherein the object includes data member values which remain unchanged when the object is changed from the first type to the second type.

6. The method as recited in claim 3, wherein the first class includes a method configured to change the object from the first type to the second type, and wherein the second class includes a method to change the object from the second type to the first type.

7. The method as recited in claim 6, wherein the method in the first class and the method in the second class have a same name, the second class inherits the method of the first class, and the method in the second class overrides the inherited method of the first class.

8. The method as recited in claim 1, wherein the object includes a pointer to a table which identifies methods of objects of the first type, and wherein changing said type further comprises changing a value of the pointer to point to a different table, wherein the different table identifies methods of objects of the second type.

9. The method as recited in claim 8, wherein changing the value of the pointer comprises calling a constructor that corresponds to a type that is not a same type as the object.

10. The method as recited in claim 1, wherein changing said type from the first type to the second type is in further response to detecting the object currently corresponds to the first type.

11. A computing system, wherein said system comprises:
a memory configured to store program instructions and data; and
a processor configured to execute program instructions, wherein the processor is configured to:
receive a request to change a state of an object stored at a given location in the memory from a first state to a second state;
change a type of the object from a first type that corresponds to the first state to a second type that corresponds to the second state, wherein to change the state the processor is configured to:
initiate creation of a new object that corresponds to the second type; and
store the new object at the given location in the memory.

12. The computing system as recited in claim 11, wherein said first type corresponds to a first class in an object oriented programming paradigm, and the second type corresponds to a second class in the paradigm.

13. The computing system as recited in claim 11, wherein the second class is a subclass of the first class.

14. The computing system as recited in claim 11, wherein a memory allocation process is not performed when the new object is created.

15. The computing system as recited in claim 14, wherein the object includes data member values which remain unchanged when the object is changed from the first type to the second type.

16. The computing system as recited in claim 13, wherein the first class includes a method configured to change the object from the first type to the second type, and wherein the second class includes a method to change the object from the second type to the first type.

17. The computing system as recited in claim 16, wherein the method in the first class and the method in the second class have a same name, the second class inherits the method of the first class, and the method in the second class overrides the inherited method of the first class.

18. The computing system as recited in claim 11, wherein the object includes a pointer to a table which identifies methods of objects of the first type, and wherein to change said type the processor is further configured to change a value of the pointer to point to a different table, wherein the different table identifies methods of objects of the second type.

19. The computing system as recited in claim 18, wherein to change the value of the pointer the processor is configured to call a constructor that corresponds to a type that is not a same type as the object.

20. The computing system as recited in claim 11, wherein the processor is configured to change said type from the first type to the second type in further response to detecting the object currently corresponds to the first type.

21. A computer readable storage medium storing program instructions, wherein the program instructions are executable to:
receive a request to change a state of an object stored at a given location in a memory from a first state to a second state;
change a type of the object from a first type that corresponds to the first state to a second type that corresponds to the second state, wherein to change said type the program instructions are executable to:
initiate creation of a new object that corresponds to the second type; and
store the new object at the given location in the memory.

22. A database system configured to store a plurality of data objects, the database system comprising:
persistent storage configured to store the plurality of data objects; and
one or more processing units configured to process the data objects;
wherein a given object stored within the database may be in one of two or more states, wherein a state of the given object is represented by a distinct object type.

23. The database system as recited in claim 22, wherein said type is encoded within the object.

24. The database system as recited in claim 23, wherein said type is implicitly encoded within the object.
